(19) United States
(12) Patent Application Publication
(10) Pub. No.: US 2011/0102691 A1
(43) Pub. Date: May 5, 2011

(54) PANEL MODULE, DRIVING CIRCUIT AND DISPLAY DEVICE

(75) Inventor: Hirokata UEHARA, Kawasaki (JP)

(73) Assignee: FUJITSU LIMITED, Kawasaki-shi (JP)

(21) Appl. No.: 12/892,917

(22) Filed: Sep. 28, 2010

(30) Foreign Application Priority Data
Sep. 29, 2009 (JP) 2009-225078

(51) Int. Cl. G02F 1/133; G06F 3/038

(52) U.S. Cl. 349/33; 345/204

(57) ABSTRACT

A display device selects one or more of first electrodes corresponding to image data using a general-purpose segment driver and applies predetermined voltages respectively to the first electrodes of selection targets and non-selection targets. A driver control circuit outputs, according to a pulse polarity control signal, inverted image data or un-inverted image data to a segment driver. The segment driver applies voltage to second electrodes based on the image data acquired from the driver control circuit.

### CROSS-REFERENCE TO RELATED APPLICATION

This application is based upon and claims the benefit of priority of the prior Japanese Patent Application No. 2009-225078, filed on Sep. 29, 2009, the entire contents of which are incorporated herein by reference.

### FIELD

The embodiments discussed herein are directed to a panel module and the like.

### BACKGROUND

In recent years, development of a display device using cholesteric liquid crystal (also referred to as chiral nematic liquid crystal) is in progress. FIG. 23 is a diagram of the structure of the cholesteric liquid crystal. As illustrated in FIG. 23, the cholesteric liquid crystal is sandwiched by two substrates. Electrodes are arrayed on the substrates in a matrix form. The substrates and the cholesteric liquid crystal are collectively referred to as a display element. The state of the cholesteric liquid crystal changes based on a voltage applied to the display element adjusted by the display device. Specifically, the state of the cholesteric liquid crystal changes to a planar state, a focal conic state, or an intermediate state, depending on the applied voltage.

The cholesteric liquid crystal in the planar state reflects light having specific wavelength. The cholesteric liquid crystal in the focal conic state transmits light. The cholesteric liquid crystal in the intermediate state is in an intermediate state between the planar state and the focal conic state. The cholesteric liquid crystal includes a chiral material. Adjusting the content of the chiral material advance allows the wavelength of the light reflected in the planar state to be adjusted. Therefore, when light such as the natural light is made incident on the cholesteric liquid crystal, the cholesteric liquid crystal can reflect demanded light of blue, green, red, or the like.

In order to display a color image on the display device, a plurality of display elements for reflecting lights having different wavelengths in response to the incident light such as the natural light are used. FIG. 24 is a diagram illustrating a display principle for the color image by the display device. As illustrated in FIG. 24, in the display device, display elements 10 to 12 corresponding respectively to blue, green, and red are laminated. Among the display elements 10 to 12, the display element 10 has cholesteric liquid crystal that reflects blue light in the planar state. The display element 11 has cholesteric liquid crystal that reflects green light in the planar state. The display element 12 has cholesteric liquid crystal that reflects red light in the planar state. The display device adjusts voltage applied to electrodes of the display elements 10 to 12 to adjust light to be reflected, thereby displaying a color image on a display surface.

The cholesteric liquid crystal has a semi-permanent display retaining characteristic. After a voltage is applied to the display element to change a state of molecular of the cholesteric liquid, the state of the molecular can be kept without the voltage being continuously applied. Therefore, the display elements are applied in a technology for electronic paper and the like because the display elements can continue to display an image, characters, and the like even in a state in which a voltage is not applied thereto.

Conventional display devices generally use a common driver and a segment driver to apply voltage to the display elements. FIG. 25 is a diagram illustrating a common driver and a segment driver in a convention display device. In FIG. 25, a display element 20c includes a plurality of first electrodes and a plurality of second electrodes on a substrate. The first electrodes are different from the second electrodes in array direction. For example, the first electrodes are arrayed in the horizontal direction of the display element 20c and the second electrodes are arrayed in the vertical direction of the display element 20c. A common driver 20a is connected to the first electrodes and a segment driver 20b is connected to the second electrodes.

The common driver 20a selects the first electrode as a selection target and applies a predetermined voltage to the first electrode as the selection target. The common driver 20a switches the first electrodes to the selection target in order one by one.

The segment driver 20b applies voltage corresponding to image data to the second electrodes to display an image in a display area on the first electrode selected by the common driver 20a. In an example illustrated in FIG. 25, in order from the left figure, the common driver 20a selects the first electrodes in first to third stages based on selection line data and the segment driver 20b applies voltage corresponding to image data to the first electrodes in order. As a result, in the display element 20c, the image is updated according to the image data in order of display areas in the first to third stages among display areas on the first electrodes. Although not illustrated in FIG. 25, the remaining display areas are updated in order according to the image data.

In the cholesteric liquid crystal, the speed of change in a state of the molecules is lower than that in normal liquid crystal. Therefore, in the method in which the common driver selects the first electrodes one by one and then applies voltage to the first electrodes to display image data in order, it is impossible to quickly cope with a change of an image. Therefore, a technology for incorporating a dedicated driver that can simultaneously select the first electrodes, interdigitated electrodes in which electrodes are arranged in interdigitated comb-like shape on the left and right of the cholesteric liquid crystal, or the like in the display device is developed.

FIG. 26 is a diagram of an example of the display device including the dedicated driver. As illustrated in FIG. 26, a dedicated driver 30a is connected to the first electrodes of the display element instead of the common driver. The dedicated driver 30a simultaneously selects the first electrodes and applies voltage to the first electrodes. A segment driver 30b simultaneously applies the voltage corresponding to image data to the second electrodes. Because the dedicated driver 30a and the like are incorporated in the display device in this way, it is possible to simultaneously select the first electrodes. It is possible to quickly cope with a change of an image compared with the method of selecting the first electrodes one by one and displaying the image data.

Patent Document: Japanese Laid-open Patent Publication No. 2008-33338.

However, the dedicated driver or the interdigitated electrodes incorporated in the display device to simultaneously select a plurality of lines leads to high manufacturing cost for the display device.

### SUMMARY

According to an aspect of an embodiment of the invention, a panel module includes a display element in which voltage is applied to a plurality of first electrodes arrayed on a substrate and a plurality of second electrodes arrayed in a direction different from a direction of the first electrodes, the display element changing a state of liquid crystal according to voltage of areas where the first electrodes and the second electrodes cross; an inverting unit that acquires polarity data indicating whether positive voltage is applied or negative voltage is applied to the first electrodes and the second electrodes and image data displayed on the display element and outputs, based on the polarity data, inverted image data or un-inverted image data; a first applying unit that selects one or more of the first electrodes corresponding to an area where the image data is displayed and applies, based on the polarity data, the positive voltage or the negative voltage to the selected one or more of the first electrodes; and a second applying unit that applies, based on the polarity data and the image data output from the inverting unit, the positive voltage and the negative voltage to the second electrodes.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram of the configuration of a panel module according to a first embodiment;

FIG. 2 is a diagram of the configuration of a display device according to a second embodiment;

FIG. 3 is a diagram of the configuration of a segment driver connected to first electrodes;

FIG. 4 is a diagram of the configuration of a segment driver connected to second electrodes;

FIG. 5 is a diagram of the configuration of a multi-voltage generating unit;

FIG. 6 is a diagram of an example of data structure of a first voltage conversion table;

FIG. 7 is a diagram of an example of data structure of a second voltage conversion table;

FIG. 8 is a diagram illustrating voltage applied to crossing areas when positive voltage is applied;

FIG. 9 is a diagram illustrating voltage applied to the crossing areas when negative voltage is applied;

FIG. 10 is a diagram of an example of a distribution of positive voltages applied to a display element;

FIG. 11 is a diagram of an example of a distribution of negative voltages applied the display element;

FIG. 12 is a diagram of the configuration of a voltage converting unit and an output driver;

FIG. 13 is a diagram illustrating driving timing for the display device according to the second embodiment;

FIG. 14 is a flowchart illustrating a processing procedure of a driver control circuit;

FIG. 15 is a diagram of the configuration of a display device as a premise of the present invention;

FIG. 16 is a diagram of the configuration of a common driver;

FIG. 17 is a diagram of the configuration of a segment driver;

FIG. 18 is a diagram of the configuration of the multi-voltage generating unit;

FIG. 19 is a diagram of an example of data structure of the first voltage conversion table;

FIG. 20 is a diagram of an example of data structure of the second voltage conversion table;

FIG. 21 is a diagram of waveforms of voltages output by the drivers;

FIG. 22 is a diagram illustrating voltage applied to a display element;

FIG. 23 is a diagram of the configuration of cholesteric liquid crystal;

FIG. 24 is a diagram illustrating a display principle for a color image by a display device;

FIG. 25 is a diagram illustrating a conventional common driver and a conventional segment driver; and

FIG. 26 is a diagram of an example of a display device including a dedicated driver.

### DESCRIPTION OF EMBODIMENTS

Preferred embodiments of the present invention will be explained with reference to accompanying drawings. The present invention is not limited to the embodiments.

### [a] First Embodiment

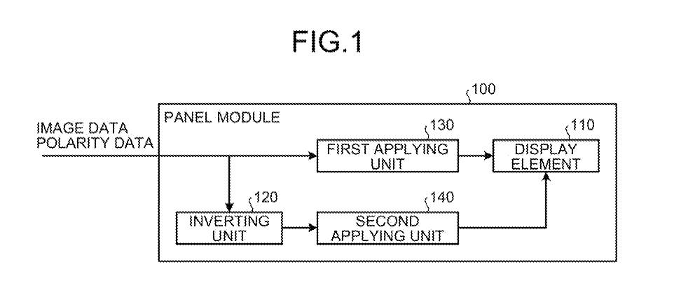

FIG. 1 is a diagram of the configuration of a panel module according to a first embodiment. As illustrated in FIG. 1, a panel module 100 includes a display element 110, an inverting unit 120, a first applying unit 130, and a second applying unit 140.

In the display element 110, voltage is applied to a plurality of first electrodes arrayed on a substrate and a plurality of second electrodes arrayed in a direction different from a direction of the array of the first electrodes. The display element 110 changes a state of liquid crystal depending on voltage in areas where the first electrodes and the second electrodes cross.

The inverting unit 120 acquires polarity data indicating whether positive voltage is applied to the first electrodes and the second electrodes or negative voltage is applied to the first electrodes and the second electrodes and image data displayed on the display element 110. The inverting unit 120 outputs, based on the polarity data, inverted image data or un-inverted image data.

The first applying unit 130 selects one or more of the first electrodes corresponding to an area where the image data is displayed and applies, based on the polarity data, positive voltage or negative voltage to the selected first electrodes.

The second applying unit 140 applies, based on the polarity data and the image data output from the inverting unit 120, positive voltage or negative voltage to the second electrodes.

The panel module 100 outputs, based on the polarity data, the inverted image data or the un-inverted image data to make it possible to use the first applying unit 130 and the second applying unit 140, which are applying units of the same type. The first applying unit 130 selects one or more of the first electrodes corresponding to the area where the image data is displayed. Therefore, the panel module 100 according to the first embodiment can quickly cope with a change of an image while suppressing manufacturing cost.

### [b] Second Embodiment

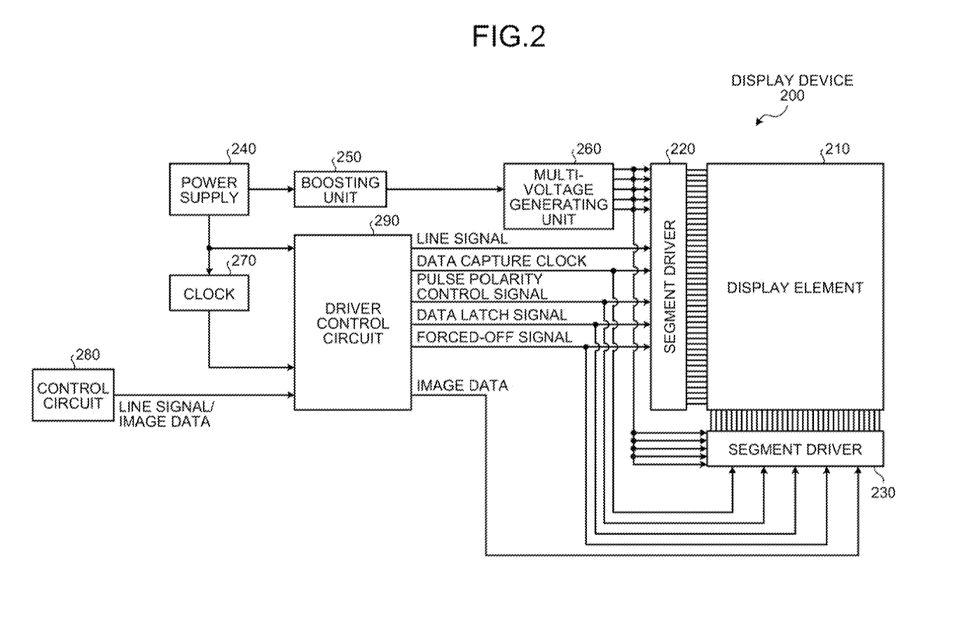

FIG. 2 is a diagram of the configuration of a display device according to a second embodiment. As illustrated in FIG. 2, a display device 200 includes a display element 210, segment drivers 220 and 230, a power supply 240, a boosting unit 250, a multi-voltage generating unit 260, a clock 270, a control circuit 280, and a driver control circuit 290.

The display element 210 is an element in which cholesteric liquid crystal is sandwiched by substrates. On the substrate of the display element, a plurality of electrodes are arrayed in a matrix form. When voltage is applied to the electrodes arrayed on the substrate, the voltage is transmitted to the cholesteric liquid crystal and a state of molecular of the cholesteric liquid crystal can be adjusted. In the following explanation, the electrodes in the horizontal direction arrayed on the substrate are referred to as first electrodes; the electrodes in the vertical direction are referred to as second electrodes.

The segment driver 220 is a circuit that is connected to the first electrodes of the display element 210 and selects, based on a signal output from the driver control circuit 290, one or more of the first electrodes corresponding to image data. The segment driver 220 applies predetermined voltage to the first electrodes as selection targets. The segment driver 220 applies voltage, which is different from the voltage applied to the first electrodes as the selection targets, to the first electrodes other than the selection targets.

The segment driver 230 is a circuit that is connected to the second electrodes of the display element 210 and applies, based on a signal output from a driver control circuit 58, voltage to the second electrodes. When the segment driver 230 applies the voltage to the second electrodes, an image corresponding to the image data is displayed in an area on the first electrodes as the selection targets. The segment drivers 220 and 230 are drivers of the same type.

The power supply 240 is a circuit that outputs predetermined voltage to the boosting unit 250, the clock 270, and the driver control circuit 290. For example, the power supply 240 outputs a voltage of 3 volts to 5 volts. The boosting unit 250 is a circuit that boosts the voltage output from the power supply 240 and outputs the boosted voltage to the multi-voltage generating unit 260.

The multi-voltage generating unit 260 is a circuit that generates various kinds of voltage from the voltage output from the boosting unit 250. The multi-voltage generating unit 260 outputs the various kinds of voltage to the segment drivers 220 and 230. The clock 270 is a circuit that outputs a clock signal to the driver control circuit 290.

The control circuit 280 is a circuit that outputs various control signals to the driver control circuit 290. As an example, the control circuit 280 outputs a line signal and image data to the driver control circuit 290.

The line signal has information for identifying the first electrodes as the selection targets among the first electrodes. The line signal includes information in which a number 1 or 0 arrayed by the number of the first electrodes. The positions of the number 1 included in the line signal correspond to the positions of the first electrodes as the selection targets, respectively. For example, when nth and mth numbers from the top of the line signal are 1, the first electrode on the nth stage and the first electrode on the mth stage from the first stage are selection targets.

The image data corresponds to data of images for one row among all images. For example, the image data includes information in which the number 1 or 0 is arrayed by the number of the second electrodes.

The driver control circuit 290 is a circuit that outputs various signals to the segment drivers 220 and 230 to control voltage applied to the display element 210. Specifically, the driver control circuit 290 outputs a data capture clock, a line signal, a data latch signal, a pulse polarity control signal, and a forced-off signal to the segment driver 220. The driver control circuit 290 outputs a data capture clock, a data latch signal, a pulse polarity control signal, a forced-off signal, and image data to the segment driver 230.

The data capture clock is a signal for notifying the segment drivers 220 and 230 of timing for capturing data. The data latch signal is a signal for notifying the segment drivers 220 and 230 of timing for moving a storage position of data.

The pulse polarity control signal is a signal for identifying whether positive voltage is applied or negative voltage is applied. Specifically, when the positive voltage is applied, the driver control circuit 290 outputs “1” to the segment driver 220 as the pulse polarity control signal and outputs “0” to the segment driver 230 as the pulse polarity control signal.

On the other hand, when the negative voltage is applied, the driver control circuit 290 outputs “1” to the segment driver 220 as the pulse polarity control signal and outputs “1” to the segment driver 230 as the pulse polarity control signal. In this way, the driver control circuit 290 determines, according to a combination of the pulse polarity control signals output to the segment drivers 220 and 230, whether the positive voltage is applied or the negative voltage is applied.

The driver control circuit 290 outputs the pulse polarity control signals to the segment drivers 220 and 230 such that, for example, the positive voltage and the negative voltage are alternately applied to the display element 210. The driver control circuit 290 prevents ions included in the display element 210 from biasing by switching the polarity of voltage according to the pulse polarity control signals.

The forced-off signal is a signal for forcibly stopping the voltage applied to the segment drivers 220 and 230.

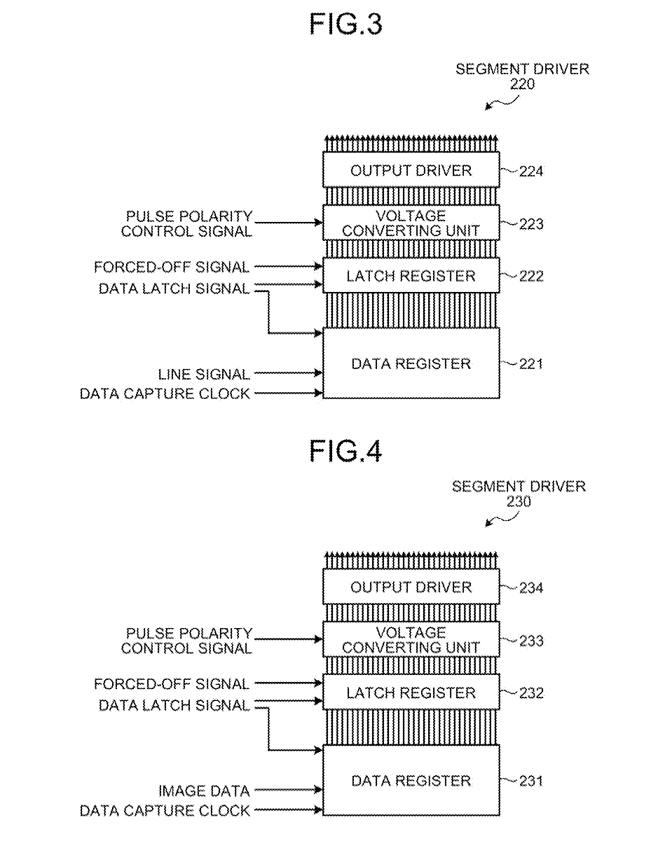

FIG. 3 is a diagram of the configuration of the segment driver connected to the first electrodes. As illustrated in FIG. 3, the segment driver 220 includes a data register 221, a latch register 222, a voltage converting unit 223, and an output driver 224.

The data register 221 is a circuit that acquires a line signal according to the data capture clock and stores the acquired line signal. The data register 221 updates, every time the line signal is acquired anew, the line signal stored therein with the new line signal.

The latch register 222 is a circuit that stores the line signal stored in the data register 221 according to timing when the data latch signal is acquired. The latch register 222 updates, every time the data latch signal is acquired, the line signal stored therein with the line signal stored in the data register 221.

The voltage converting unit 223 is a circuit that selects, based on the line signal stored in the latch register 222, the first electrodes as the selection targets among the first electrodes of the display element 210. The voltage converting unit 223 determines, referring to a bit string of the line signal stored in the latch register 222, the positions of 1 included in the bit string. The voltage converting unit 223 selects, based on the positions of 1, the first electrodes as the selection targets. For example, when the nth and mth bits from the top of the signal are “1”, the voltage converting unit 223 sets the nth and mth first electrodes as selection targets.

The voltage converting unit 223 notifies positions of the output driver 224 corresponding to the first electrodes as the selection targets and the first electrodes as non-selection targets of voltage to be applied. The voltage converting unit 223 switches, according to the pulse polarity control signal, the voltage applied to the first electrodes as the selection targets and the first electrodes as the non-selection targets to positive polarity or negative polarity. A specific value of the voltage notified to the output driver 224 by the voltage converting unit 223 is explained later.

The output driver 224 is a circuit that is connected to the first electrodes of the display element 210 and applies pertinent voltage to the first electrodes according to information notified from the voltage converting unit 223. The voltage applied to the output driver 224 is supplied from the multi-voltage generating unit 260.

FIG. 4 is a diagram of the configuration of the segment driver connected to the second electrodes. As illustrated in FIG. 4, the segment driver 230 includes a data register 231, a latch register 232, a voltage converting unit 233, and an output driver 234.

The data register 231 is a circuit that acquires image data according to the data capture clock and stores the acquired image data. The data register 231 updates, every time the image data is acquired anew, the image data stored therein with the new image data.

The latch register 232 is a circuit that stores, according to timing when the data latch signal is acquired, the image data stored in the data register 231. The latch register 232 updates, every time the data latch signal is acquired, the image data stored therein with the image data stored in the data register 231.

The voltage converting unit 233 is a circuit that notifies, based on the image data stored in the latch register 232, the output driver 234 of voltage applied to the second electrodes. The image data has information of 1 or 0 by the number of the second electrodes and nth information of the image data corresponds to the second electrodes in an nth column. The voltage converting unit 233 notifies positions of the output driver 234 corresponding to the second electrodes in the nth column of voltage corresponding to nth information of the image data. The voltage converting unit 233 switches, according to the pulse polarity control signal, the polarity to be applied to positive polarity or negative polarity. A specific value of the voltage notified to the output driver 234 by the voltage converting unit 233 is explained later.

The output driver 234 is a circuit that is connected to the second electrodes of a display element 51 and applies pertinent voltage to the second electrodes according to information notified from the voltage converting unit 72. The voltage applied by the output driver 234 is supplied from the multi-voltage generating unit 260.

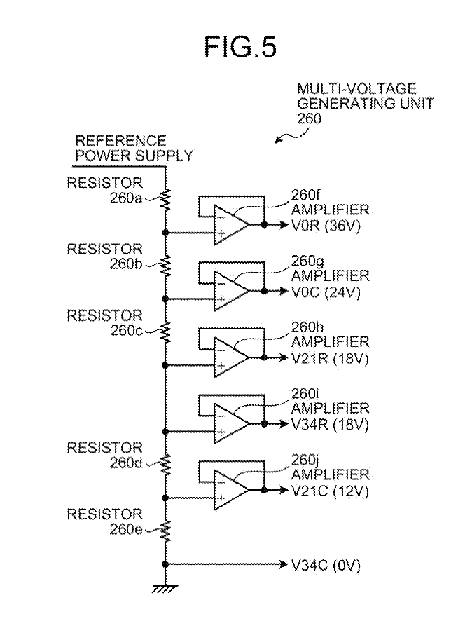

FIG. 5 is a diagram of the configuration of the multi-voltage generating unit 260 illustrated in FIG. 2. As illustrated in FIG. 5, the multi-voltage generating unit 260 includes resistors 260a to 260e and amplifiers 260f to 260j. Reference voltage of the multi-voltage generating unit 260 corresponds to voltage output from the boosting unit 250. The resistors 260a to 260e are electric resistors.

The amplifier 260f is a circuit that acquires the reference voltage via the resistor 260a, amplifies the acquired voltage, and outputs a voltage of 36 volts. The voltage output by the amplifier 260f is represented as V0R. The amplifier 260g is a circuit that acquires the reference voltage via the resistors 260a and 260b, amplifies the acquired voltage, and outputs a voltage of 24 volts. The voltage output by the amplifier 260g is represented as V0C.

The amplifier 260h is a circuit that acquires the reference voltage via the resistors 260a to 260c, amplifies the acquired voltage, and outputs a voltage of 18 volts. The voltage output by the amplifier 260h is represented as V21R. The amplifier 260i is a circuit that acquires the reference voltage via the resistors 260a to 260c, amplifies the acquired voltage, and outputs a voltage of 18 volts. The voltage output by the amplifier 260i is represented as V34R.

The amplifier 260j is a circuit that acquires the reference voltage via the resistors 260a and 260d, amplifies the acquired voltage, and outputs a voltage of 12 volts. The voltage output by the amplifier 260j is represented as V21C. Voltage connected to the earth is represented as V34R. Voltage V34C is 0 volt because the voltage V34C is connected to the earth.

In FIG. 5, a relation of V0R≧V21R≧V34R≧0 V is kept. A relation of V0C≧V21C≧V34R≧0 V is kept.

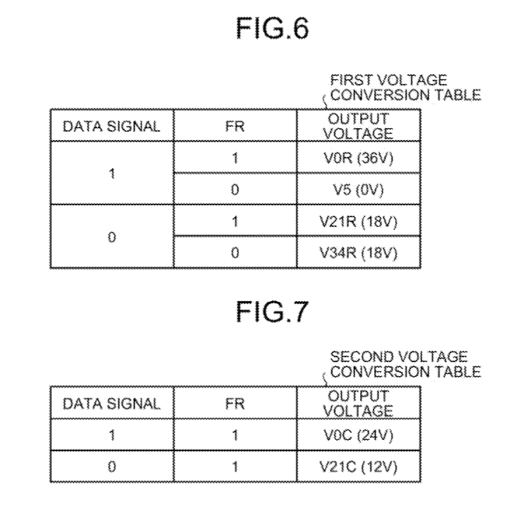

Voltage notified to the output driver 234 by the voltage converting unit 233 illustrated in FIG. 3 is explained. For example, the voltage converting unit 233 stores a first voltage conversion table. The voltage converting unit 233 determines voltage applied to the first electrodes to correspond to such a first voltage conversion table. FIG. 6 is a diagram of an example of data structure of the first voltage conversion table. As illustrated in FIG. 6, the first voltage conversion table associates a data signal, FR, and output voltage.

The data signal is information for identifying whether the first electrodes are the first electrodes as the selection targets. When the data signal is “1”, the first electrodes are the first electrodes as the selection targets. When the data signal is “0”, the first electrodes are the first electrodes as the non-selection targets.

The FR is information for identifying whether voltage applied to the first electrodes is positive voltage or negative voltage. When the FR is “0”, the positive voltage is applied to the first electrodes. When the FR is “1”, the negative voltage is applied to the first electrodes.

The output voltage is information for identifying voltage output from the output driver 224. The output voltages V0R, V21R, and V34R correspond to voltages output from the amplifiers 260f, 260h, and 260i illustrated in FIG. 5, respectively. Specifically, V0R is 36 volts, V21R is 18 volts, and V34R is 18 volts. The output voltage V5 is 0 volt.

When the positive voltage is applied to the first electrodes as the selection targets, in FIG. 6, the data signal is “1” and the RF is “0”. Output voltage corresponding to this combination is “V5”. The output voltage V5 corresponds to 0 volt. Therefore, the voltage converting unit 223 determines that the voltage applied to the first electrodes as the selection targets is “0 volt” and outputs a determination result to the output driver 224.

When the negative voltage is applied to the first electrodes as the selection targets, in FIG. 6, the data signal is “1” and the FR is “1”. Output voltage corresponding to this combination is “V0R”. The output voltage V0R corresponds to 36 volts. Therefore, the voltage converting unit 223 determines that the voltage applied to the first electrodes as the selection targets is “36 volts” and outputs a determination result to the output driver 224.

When the positive voltage is applied to the first electrodes as the non-selection targets, in FIG. 6, the data signal is “0” and the RF is “0”. Output voltage corresponding to this combination is “V34R”. The output voltage V34R corresponds to 18 volts. Therefore, the voltage converting unit 223 determines that the voltage applied to the first electrodes as the non-selection targets is “18 volts” and outputs a determination result to the output driver 224.

When the negative voltage is applied to the first electrodes as the non-selection targets, in FIG. 6, the data signal is “0” and the FR is “1”. Output voltage corresponding to this combination is “V21R”. The output voltage V24R corresponds to 18 volts. Therefore, the voltage converting unit 223 determines that the voltage applied to the first electrodes as the non-selection targets is “18 volts” and outputs a determination result to the output driver 224.

Voltage notified to the output driver 234 by the voltage converting unit 233 illustrated in FIG. 4 is explained. For example, the voltage conversing unit 233 stores a second voltage conversion table. The voltage converting unit 233 determines voltage applied to the second electrodes to correspond to such a second voltage conversion table. FIG. 7 is a diagram of an example of data structure of the second voltage conversion table. As illustrated in FIG. 7, the second voltage conversion table associates a data signal, FR, and output voltage.

The data signal corresponds to numbers of bit strings included in image data. The FR is information for identifying whether voltage applied to the second electrodes is positive voltage or negative voltage. In the second voltage conversion table in the second embodiment, a value of the RF is fixed to “1” irrespective of the polarity of voltage to be applied. In other words, when the positive voltage is applied and when the negative voltage is applied, FR=1.

The output voltage is information for identifying voltage output from the output driver 234. The output voltages V0C and V21C correspond to voltages output from the amplifiers 260g and 260j illustrated in FIG. 5. Specifically, V0C is 24 volts and V21C is 12 volts.

In the following explanation, voltage applied to the second electrodes in the nth column is determined. When the nth bit of image data is “1” and positive (or negative) voltage is applied, in FIG. 7, the data signal is “1” and the FR is “1”. Output voltage corresponding to this combination is “V0C”. The output voltage V0 corresponds to 24 volts. The voltage converting unit 233 determines that the voltage applied to the second electrodes in the nth column is “24 volts” and outputs a determination result to the output driver 234.

When the nth bit of the image data is “0” and positive (or negative) voltage is applied, in FIG. 7, the data signal is “0” and the FR is “1”. Output voltage corresponding to this combination is “V21C”. The output voltage V21C corresponds to 12 volts. The voltage converting unit 233 determines that the voltage applied to the second electrodes in the nth column is “12 volts” and outputs a determination result to the output driver 234.

Voltage applied to the display element 210 is explained. As an example, it is assumed that voltage obtained by subtracting voltage applied to the first electrodes by the segment driver 220 from voltage applied to the second electrodes by the segment driver 230 is applied to crossing areas. The crossing areas are areas where the first electrodes and the second electrodes cross.

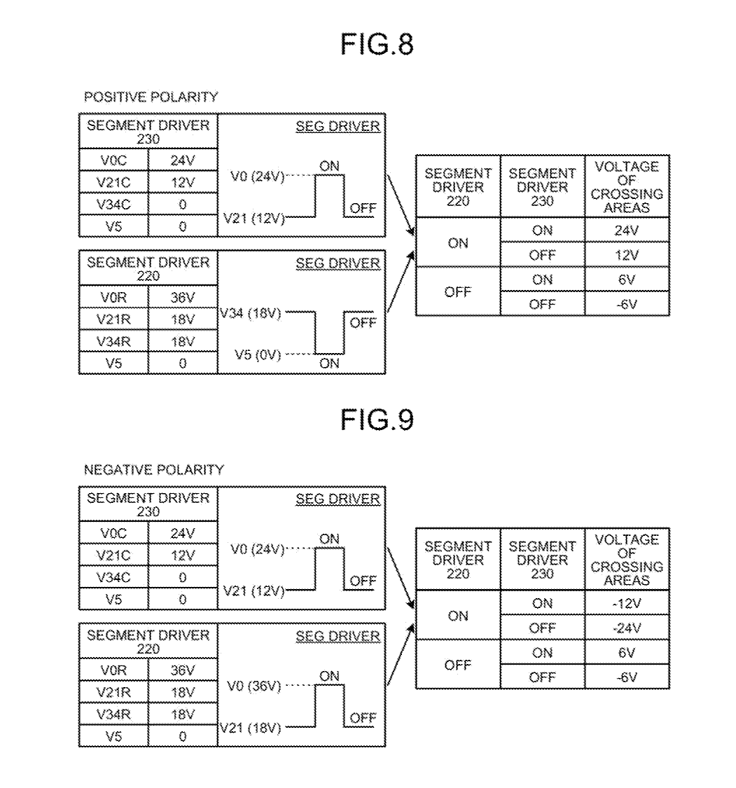

FIG. 8 is a diagram illustrating voltage applied to the crossing areas when the segment drivers 220 and 230 are “ON” or “OFF” when positive voltage is applied.

As illustrated on the lower left in FIG. 8, when the segment driver 220 is “ON”, the segment driver 220 applies a voltage of 0 volt to the first electrodes. When the segment driver 220 is “OFF”, the segment driver 220 applies a voltage of 18 volts to the first electrodes. The first electrodes for which the segment driver 220 is “ON” are the first electrodes as the selection targets. The first electrodes for which the segment driver 220 is “OFF” are the first electrodes as the non-selection targets.

As illustrated on the upper left in FIG. 8, when the segment driver 230 is “ON”, the segment driver 230 applies a voltage of 24 volts to the second electrodes. When the segment driver 230 is “OFF”, the segment driver 230 applies a voltage of 12 volts to the second electrodes. The second electrodes for which the segment driver 230 is “ON” are electrodes corresponding to “1” of the image data. The second electrodes for which the segment driver 230 is “OFF” are electrodes corresponding to “0” of the image data.

As illustrated on the right side in FIG. 8, when the segment driver 220 is ON and the segment driver 230 is ON, when the positive voltage is applied, 0 volt is applied to the first electrodes and 24 volts is applied to the second electrodes. As a result, a voltage of 24 volts is applied to the crossing areas.

When the segment driver 220 is ON and the segment driver 230 is OFF, when the positive voltage is applied, 0 volt is applied to the first electrodes and 12 volts is applied to the second electrodes. As a result, a voltage of 12 volts is applied to the crossing areas.

When the segment driver 220 is OFF and the segment driver 230 is ON, when the positive voltage is applied, 18 volts is applied to the first electrodes and 24 volts is applied to the second electrodes. As a result, a voltage of 6 volts is applied to the crossing areas.

When the segment driver 220 is OFF and the segment driver 230 is OFF, when the positive voltage is applied, 18 volts is applied to the first electrodes and 12 volts is applied to the second electrodes. As a result, a voltage of −6 volts is applied to the crossing areas.

FIG. 9 is a diagram illustrating voltage applied to the crossing areas when the segment drivers 220 and 230 are “ON” or “OFF” when negative voltage is applied.

As illustrated on the lower left in FIG. 9, when the segment driver 220 is “ON”, the segment driver 220 applies a voltage of 36 volts to the first electrodes. When the segment driver 220 is “OFF”, the segment driver 220 applies a voltage of 18 volts to the first electrodes. The first electrodes for which the segment driver 220 is “ON” are the first electrodes as the selection targets. The first electrodes for which the segment driver 220 is “OFF” are the first electrodes as the non-selection targets.

As illustrated on the upper left in FIG. 9, when the segment driver 230 is “ON”, the segment driver 230 applies a voltage of 24 volts to the first electrodes. When the segment driver 230 is “OFF”, the segment driver 230 applies a voltage of 12 volts to the first electrodes. The second electrodes for which the segment driver 230 is “ON” are electrodes corresponding to “1” of the image data. The second electrodes for which the segment driver 230 is “OFF” are electrodes corresponding to “0” of the image data.

As illustrated on the right side in FIG. 9, when the segment driver 220 is ON and the segment driver 230 is OFF, when the negative voltage is applied, 36 volts is applied to the first electrodes and 24 volts is applied to the second electrodes. As a result, a voltage of −12 volts is applied to the crossing areas.

When the segment driver 220 is ON and the segment driver 230 is OFF, when the negative voltage is applied, 36 volts is applied to the first electrodes and 12 volts is applied to the second electrodes. As a result, a voltage of −24 volts is applied to the crossing areas.

When the segment driver 220 is OFF and the segment driver 230 is ON, when the negative voltage is applied, 18 volts is applied to the first electrodes and 24 volts is applied to the second electrodes. As a result, a voltage of 6 volts is applied to the crossing areas.

When the segment driver 220 is OFF and the segment driver 230 is OFF, when the negative voltage is applied, 18 volts is applied to the first electrodes and 12 volts is applied to the second electrodes. As a result, a voltage of −6 volts is applied to the crossing areas.

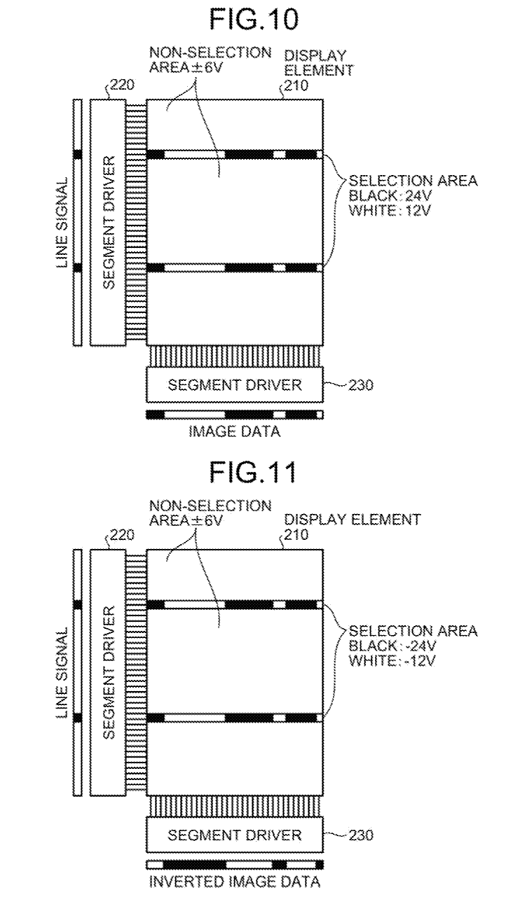

FIG. 10 is a diagram of an example of a distribution of positive voltages applied to the display element 210. In FIG. 10, selection areas are areas of the display element corresponding to the first electrodes as the selection targets. Non-selection areas are areas of the display element 210 corresponding to the first electrodes as the non-selection targets.

As illustrated in FIG. 10, a voltage of −6 volts or 6 volts is applied to the non-selection areas. A state of the cholesteric liquid crystal does not change at the voltage of −6 volts or 6 volts and is kept.

A voltage of 12 volts or 24 volts is applied to the selection area. When the voltage of 12 volts is applied, the state of the cholesteric liquid crystal changes to a planar state in which the cholesteric liquid crystal reflects light. When the voltage of 24 volts is applied, the state of the cholesteric liquid crystal changes to a focal conic state in which the cholesteric liquid crystal transmits light.

FIG. 11 is a diagram of an example of a distribution of negative voltages applied to the display element 210. As illustrated in FIG. 11, a voltage of −6 volts or 6 volts is applied to the non-selection areas. A voltage of −12 volts or −24 volts is applied to the selection areas. Original data of inverted data illustrated in FIG. 11 is the same as the image data illustrated in FIG. 10. When the negative voltage is applied, an absolute value of the applied voltage is opposite to an absolute value of the positive voltage. Therefore, when the segment driver 230 applies voltage based on the inverted image data, an image displayed on the display element 210 illustrated in FIG. 11 is the same as the image data displayed on the display element 210 illustrated in FIG. 10.

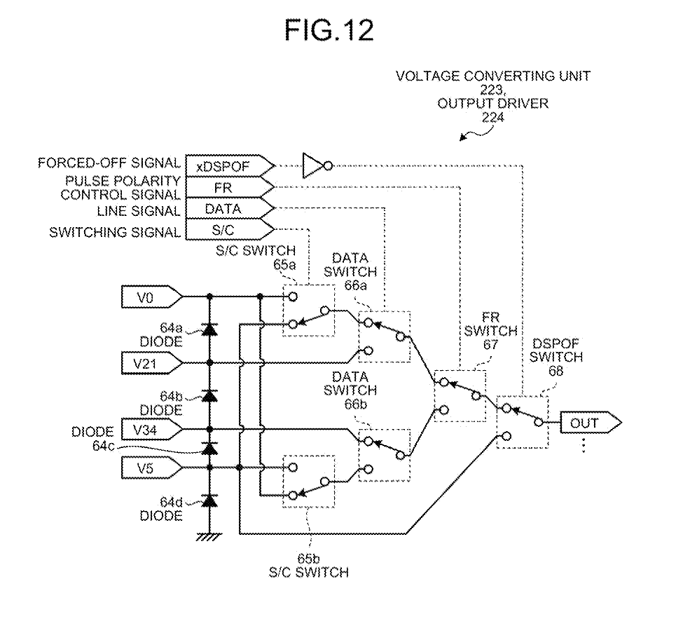

FIG. 12 is a diagram of the configuration of the voltage converting unit and the output driver. As illustrated in FIG. 12, the voltage converting unit 223 and the output driver 224 include diodes 64a to 64d, S/C switches 65a and 65b, data switches 66a and 66b, an FR switch 67, and a DSPOF switch 68.

Voltage output from the DSPOF switch 68 is applied to the first electrodes set in advance among the first electrodes. In the figure, only the S/C switches 65a and 65b, the data switches 66a and 66b, the FR switch 67, and the DSPOF switch 68 are illustrated. However, the switches are present by a number corresponding to the first electrodes. The diodes 64a to 64d are elements that feed electric current in one direction.

The S/C switches 65a and 65b are switches for switching the common driver or the segment drivers. The S/C switches 65a and 65b included in the segment drivers 220 are connected to a channel on a lower side of upper and lower channels. The S/C switches 65a and 65b are switched according to a switching signal.

The data switches 66a and 66b are switches switched according to a data signal. When the data signal is “1”, the data switches 66a and 66b are connected to the channel on the upper side. When the data signal is “0”, the data switches 66a and 66b are connected to the channel on the upper side. The first electrodes connected to an end of the DSPOF switch 68 are the first electrodes as the selection targets, the data signal is “1”. When the first electrodes connected to the end of the DSPOF switch 68 are the first electrodes as the non-selection targets, the data signal is “0”.

The FR switch 67 is a switch that acquires the pulse polarity control signal and is switched according to the acquired pulse polarity control signal. When the pulse polarity control signal is “1”, the FR switch 67 is connected to the channel on the upper side. When the pulse polarity control signal is “0”, the FR switch 67 is connected to the channel on the lower side.

The DSPOF switch 68 is a switch that is switched according to the forced-off signal. For example, when the forced-off signal is “1”, the DSPOF switch 68 is connected to the channel on the upper side. When the forced-off signal is “0”, the DSPOF switch 68 is connected to the channel on the lower side. When the forced-off signal is “1”, the DSPOF switch 68 continues the application of voltage to the first electrodes. On the other hand, when the forced-off signal is “0”, the DSPOF switch 68 forcibly suspends the application of voltage to the first electrode.

The configuration of the voltage converting unit 233 and the output driver 234 illustrated in FIG. 3 is the same as the configuration of the voltage converting unit 223 and the output driver 224 illustrated in FIG. 12. However, voltage output from the DSPOF switch 68 is applied to the second electrodes set in advance among the second electrodes. Image data is input to the Data switches 66a and 66b.

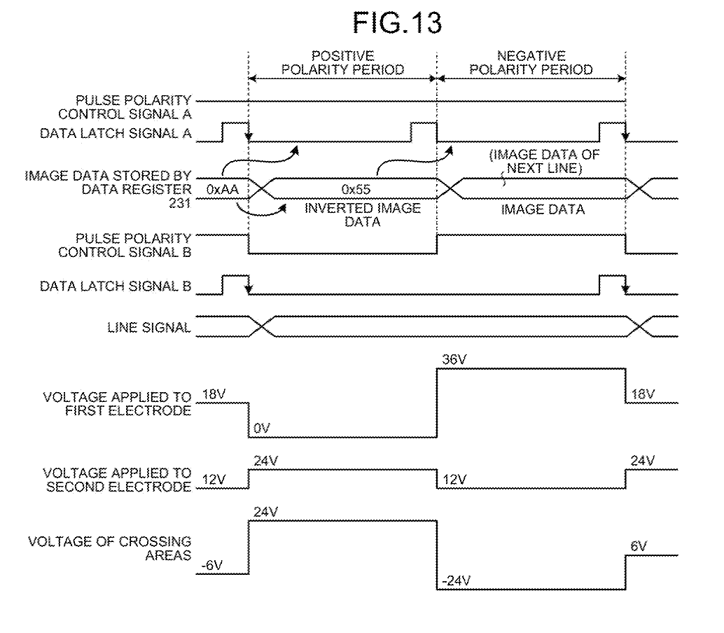

FIG. 13 is a diagram illustrating driving timing for the display device 200 according to the second embodiment. In FIG. 13, as an example, positive voltage and negative voltage are alternately applied to the first electrodes and the second electrodes.

In FIG. 13, a pulse polarity control signal A is a pulse polarity control signal input to the segment driver 230. The pulse polarity control signal A is always “1” irrespective of a period in which the positive voltage is applied and a period in which the negative voltage is applied.

A data latch signal A is a signal that is input to the segment driver 230 and switched to fixed periods “1” and “0” at a fixed cycle. At a point when the data latch signal A is switched from 1 to 0, the segment driver 230 shifts image data from the data register 231 to the latch register 232. The data register 231 stores the image data output from the driver control circuit 290.

At a point when a value of the data latch signal A is switched from 1 to 0, the data register 231 stores image data output from the driver control circuit 290. Image data stored by the data register 231 in a period of positive polarity is an inverted image. Image data stored by the data register 231 in a period of negative polarity is un-inverted image data.

A pulse polarity control signal B is a pulse polarity control signal input to the segment driver 220. The pulse polarity control signal B is switched to a period “0” in which the positive voltage is applied and switched to a period “1” in which the negative voltage is applied.

A data latch signal B is a signal that is input to the segment driver 220 and switched to fixed periods “1” and “0” at a fixed cycle. At a point when the data latch signal B is switched from 1 to 0, the segment driver 220 shifts a line signal from the data register 221 to the latch register 222. The data register 221 stores the line signal output from the driver control circuit 290. The line signal is a signal for identifying the first electrodes as the selection targets among the first electrodes.

As illustrated on a lower side in FIG. 13, when the voltage of a predetermined crossing area is set to 24 volts in a period of positive polarity, the voltage applied to the first electrodes is 0 volt and the voltage applied to the second electrodes is 24 volts. When the voltage of the predetermined crossing area is set to −24 volts in a period of negative polarity, the voltage applied to the first electrodes is 36 volts and the voltage applied to the second electrodes is 12 volts.

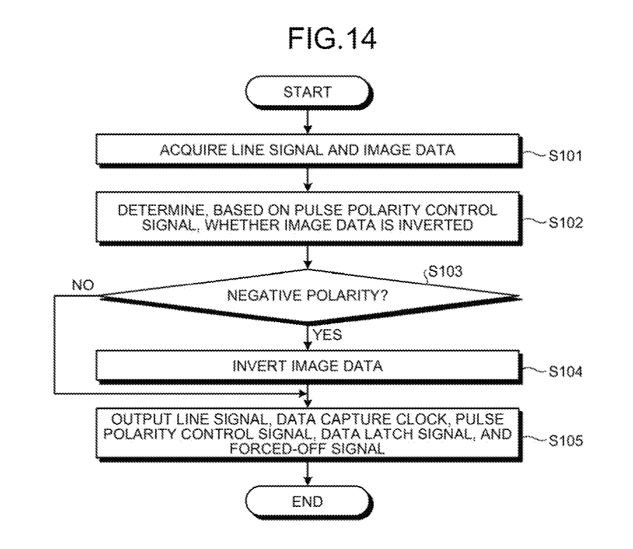

FIG. 14 is a flowchart of a processing procedure of the driver control circuit 290. As illustrated in FIG. 14, the driver control circuit 290 acquires the line signal and the image data from the control circuit 280 (step S101).

The driver control circuit 290 determines, based on the pulse polarity control signal, whether the image data is inverted (step S102). When the pulse polarity control signal is set to the positive polarity (No at step S103), the driver control circuit 290 shifts to step S105 without inverting the image data.

When the pulse polarity control signal is set to the negative polarity (Yes at step S103), the driver control circuit 290 inverts the image data (step S104). The driver control circuit 290 outputs a line signal, a data capture clock, a pulse polarity control signal, a data latch signal, and a forced-off signal (step S105).

As explained above, the display device 200 according to the second embodiment selects, using the genera-purpose segment driver 220, one or more of the first electrodes corresponding to the image data and applied predetermined voltages to the first electrodes as the selection targets and the non-selection targets. The driver control circuit 290 outputs, according to the pulse polarity control signal, inverted image data or un-inverted image data to the segment driver 230. The segment driver 230 applies voltage to the second electrodes based on the image data acquired from the driver control circuit 290.

When the general-purpose segment driver 220 is used instead of the common driver, a relation of voltages of the selection areas is inverted. Because the display device 200 according to the second embodiment inverts the image data itself, the display device 200 according to the second embodiment can accurately display the image data even when the relation of the voltages of the selection areas is inverted.

Therefore, the display device 200 according to the second embodiment simultaneously selects a plurality of first electrodes using the general-purpose segment driver. Therefore, the display device 200 can quickly cope with a change of an image compared with the method of selecting the first electrodes one by one.

When the negative voltage is applied to the first electrode and the second electrode, the display device 200 according to the second embodiment inverts the image data. Therefore, even when the positive and negative voltages are alternately applied, the display device 200 can accurately display the image data using the two segment drivers 220 and 230.

The components of the devices illustrated in the figures are functionally conceptual and do not always need to be physically configured as illustrated in the figure. Specific forms of distribution and integration of the devices are not limited to those illustrated in the figures. All or a part of the devices can be functionally or physically distributed or integrated in an arbitrary unit according to various loads, states of use, and the like. For example, the driver control circuit 290 can be provided in a device on the outside of the display device 200 and the driver control circuit 290 can output various signals to the segment drivers 220 and 230 from the outside.

The configuration of the display device 200 according to this embodiment illustrated in FIG. 2 can be variously changed without departing from the spirit of the present invention. For example, the functions of the driver control circuit 290 are implemented as software and execute by a computer, whereby functions equivalent to those of the driver control circuit 290 can be realized.

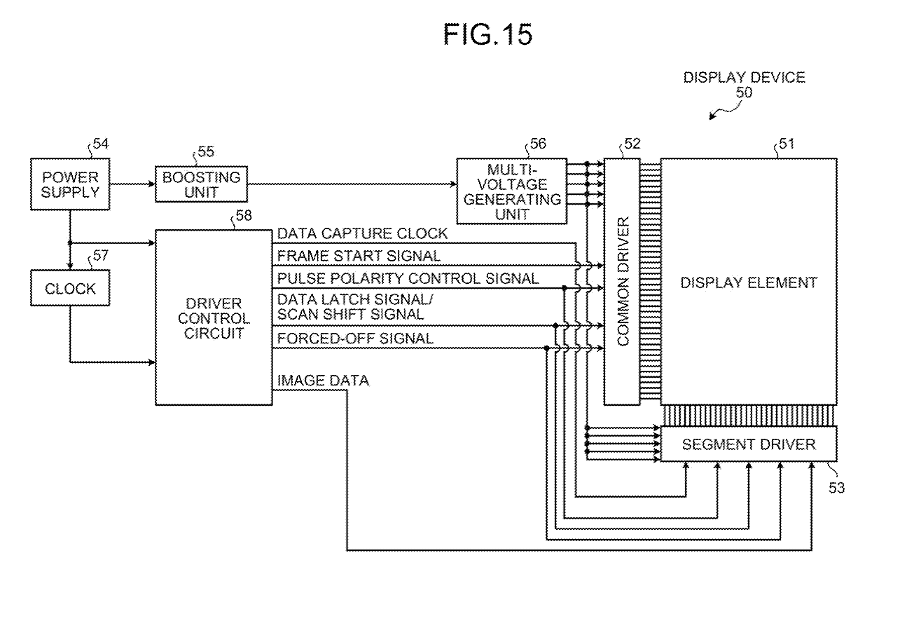

FIG. 15 is a diagram of a display device as a premise of the display device 200 according to the second embodiment. As illustrated in FIG. 15, a display device 50 includes a display element 51, a common driver 52, a segment driver 53, a power supply 54, a boosting unit 55, a multi-voltage generating unit 56, a clock 57, and a driver control circuit 58.

Explanation of the display element 51, the segment driver 53, the power supply 54, the boosting unit 55, and the clock is the same as the explanation of the display element 210, the segment driver 230, the power supply 240, the boosting unit 250, and the clock 270 illustrated in FIG. 2.

The common driver 52 is a circuit that is connected to first electrodes of the display element 51 and selects one first electrode based on a signal output from the driver control circuit 58. The common driver 52 applies predetermined voltage to the first electrode as a selection target. The common driver 52 applies voltage, which is different from the voltage applied to the first electrode as the selection target, to the first electrodes other than the selection target.

The multi-voltage generating unit 56 is a circuit that generates a plurality of kinds of voltage from voltage output from the boosting unit 55. The multi-voltage generating unit 56 outputs the kinds of voltage to the common driver 52 and the segment driver 53. The clock 57 is a circuit that outputs a clock signal to the driver control circuit 58.

The driver control circuit 58 is a circuit that outputs various signals to the common driver 52 and the segment driver 53 to control voltage applied to the display element 51. Specifically, the driver control circuit 58 outputs a frame start signal, a scan shift signal, a pulse polarity control signal, and a forced-off signal to the common driver 52. The driver control circuit 58 outputs a data capture clock, a data latch signal, a pulse polarity control signal, a forced-off signal, and image data to the segment driver 53.

The frame start signal is a signal for causing the common driver 52 to select the first electrode on a first stage. The scan shift signal is a signal for notifying timing for switching the first electrode as the selection target. Specifically, the common driver 52 selects the first electrode on the first stage when the frame start signal is acquired and subsequently switch the first electrode as the selection target in order every time the scan shift signal is acquired.

The pulse polarity control signal is a signal for identifying whether positive voltage is applied or negative voltage is applied. When the positive voltage is applied, pulse polarity output by the driver control circuit 58 is “1”. When the negative voltage is applied, the pulse polarity output by the driver control circuit 58 is “0”.

Explanation of the forced-off signal, the data capture clock, the data latch signal, and the image data is the same as the above explanation of the forced-off signal, the data capture clock, the data latch signal, and the image data.

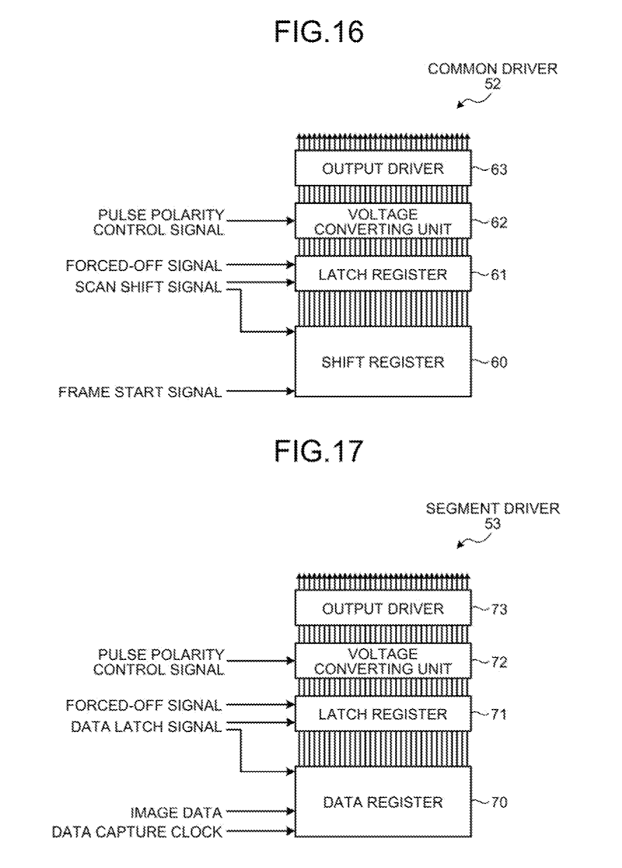

FIG. 16 is a diagram of the configuration of the common driver 52 illustrated in FIG. 15. As illustrated in FIG. 16, the common driver 52 includes a shift register 60, a latch register 61, a voltage converting unit 62, and an output driver 63.

The shift register 60 is a circuit that sequentially stores the frame start signal and the scan shift signal output from the driver control circuit 58. First, the driver control circuit 58 outputs the frame start signal once and, thereafter, sequentially outputs the scan shift signal. The shift register 60 updates, every time a signal is acquired from the driver control circuit 58, a signal stored so far with the signal acquired anew. The latch register 61 is a circuit that stores a signal same as the signal stored in the shift register 60.

The frame start signal is a signal including a bit string in which a start bit is “1” and the remaining bits are “0”. The scan shift signal includes a bit string of “1 or 0” in which a start bit is “0” and any one of the remaining bits is “1”.

The voltage converting unit 62 is a circuit that selects, based on the signal stored in the latch register 61, the first electrode as the selection target among the first electrodes of the display element 51. The voltage converting unit 62 determines, referring to a bit string of the signal stored in the latch register 61, the position of 1 included in the bit string. The voltage converting unit 62 selects the first electrode as the selection target based on the position of 1. For example, when the nth bit from the top is “1”, the voltage converting unit 62 sets the nth first electrode as the selection target.

The voltage converting unit 62 notifies positions of the output driver 63 corresponding to the first electrode as the selection target and the first electrodes as non-selection targets of voltage to be applied. The voltage converting unit 62 switches, according to the pulse polarity control signal, the voltage applied to the first electrode as the selection target and the first electrodes as the non-selection targets to positive polarity or negative polarity. A specific value of the voltage notified to the output driver 63 by the voltage converting unit 62 is explained later.

The output driver 63 is a circuit that is connected to the first electrodes of the display element 51 and applies pertinent voltage to the first electrodes according to information notified from the voltage converting unit 62. The voltage applied to the output driver 63 is supplied from the multi-voltage generating unit 56.

FIG. 17 is a diagram of the configuration of the segment driver 53 in the past illustrated in FIG. 15. As illustrated in FIG. 17, the segment driver 53 includes a data register 70, a latch register 71, a voltage converting unit 72, and an output driver 73.

The data register 70 is a circuit that acquires image data according to the data capture clock and stores the acquired image data. The data register 70 updates, every time the image data is acquired anew, the image data stored therein with the new image data.

The latch register 71 is a circuit that stores, according to timing when the data latch signal is acquired, the image data stored in the data register 70. The latch register 71 updates, every time the data latch signal is acquired, the image data stored therein with the image data stored in the data register 70.

The voltage converting unit 72 is a circuit that notifies, based on the image data stored in the latch register 71, the output driver of voltage applied to the second electrodes. The image data has information of 1 or 0 by the number of the second electrodes and nth information of the image data corresponds to the nth second electrode. The voltage converting unit 72 notifies a position of the output driver 73 corresponding to the nth second electrode of voltage corresponding to nth information of the image data. The voltage converting unit 72 switches, according to the pulse polarity control signal, the polarity to be applied to positive polarity or negative polarity. A specific value of the voltage notified to the output driver 73 by the voltage converting unit 72 is explained later.

The output driver 73 is a circuit that is connected to the second electrodes of the display element 51 and applies pertinent voltage to the second electrodes according to information notified from the voltage converting unit 72. The voltage applied by the output driver 73 is supplied from the multi-voltage generating unit 56.

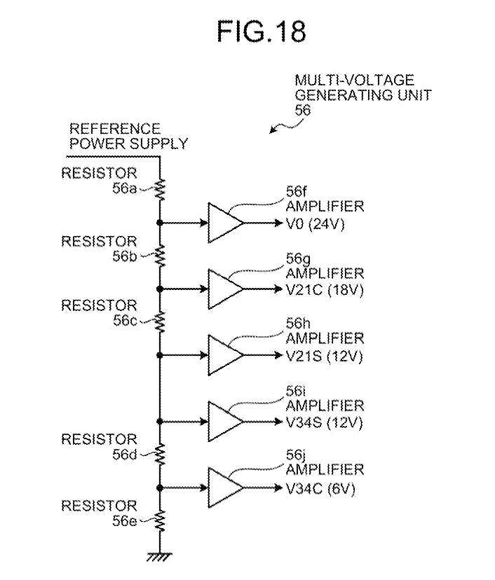

FIG. 18 is a diagram of the configuration of the multi-voltage generating unit 56 in the past illustrated in FIG. 15. As illustrated in FIG. 18, the multi-voltage generating unit 56 includes resistors 56a to 56e and amplifiers 56f to 56j. Reference voltage of the multi-voltage generating unit 56 corresponds to voltage output from the boosting unit 55.

The amplifier 56f is a circuit that acquires the reference voltage via the resistor 56a, amplifies the acquired voltage, and outputs a voltage of 24 volts. The voltage output by the amplifier 56f is represented as V0. The amplifier 56g is a circuit that acquires the reference voltage via the resistors 56a and 56b, amplifies the acquired voltage, and outputs a voltage of 18 volts. The voltage output by the amplifier 56g is represented as V21C.

The amplifier 56h is a circuit that acquires the reference voltage via the resistors 56a to 56c, amplifies the acquired voltage, and outputs a voltage of 12 volts. The voltage output by the amplifier 56h is represented as V21S. The amplifier 56i is a circuit that acquires the reference voltage via the resistors 56a to 56c, amplifies the acquired voltage, and outputs a voltage of 12 volts. The voltage output by the amplifier 56i is represented as V34S.

The amplifier 56j is a circuit that acquires the reference voltage via the resistors 56a and 56d, amplifies the acquired voltage, and outputs a voltage of 6 volts. The voltage output by the amplifier 56j is represented as V34C. The multi-voltage generating unit 56 outputs the voltages V0, V21C, V21S, V34S, and V34C to the common drivers 52 and the segment driver 53.

In FIG. 18, a relation of V0≧V21C≧V34C≧0 V is satisfied. A relation of V0≧V21S≧V34S≧0 V is satisfied.

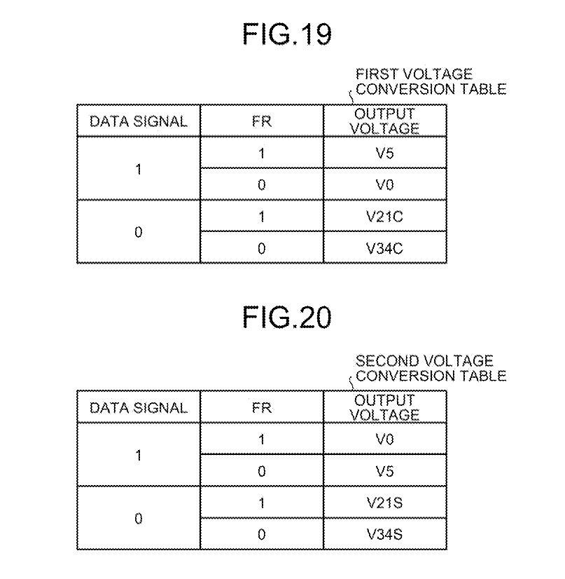

Voltage notified to the output driver 63 by the voltage converting unit 62 illustrated in FIG. 15 is explained. The voltage converting unit 62 stores a first voltage conversion table. The voltage converting unit 62 determines voltage applied to the first electrodes to correspond to such a first voltage conversion table. FIG. 19 is a diagram of an example of data structure of the first voltage conversion table. As illustrated in FIG. 19, the first voltage conversion table associates a data signal, FR, and output voltage.

The data signal is information for identifying whether the first electrode is the first electrode as the selection target. When the data signal is “1”, the first electrode is the first electrode as the selection target.

When the data signal is “0”, the first electrode is the first electrode as the non-selection target.

The FR is information for identifying whether voltage applied to the first electrodes is positive voltage or negative voltage. When the FR is “1”, the positive voltage is applied to the first electrodes. When the FR is “0”, the negative voltage is applied to the first electrodes.

The output voltage is information for identifying voltage output from the output driver 63. The output voltages V0, V2CR, and V34C correspond to voltages output from the amplifiers 56f, 56h, and 56i illustrated in FIG. 18, respectively. Specifically, V0 is 24 volts, V21C is 18 volts, and V34C is 6 volts. The output voltage V5 is 0 volt.

When the positive voltage is applied to the first electrode as the selection target, in FIG. 19, the data signal is “1” and the RF is “1”. Output voltage corresponding to this combination is “V5”. The output voltage V5 corresponds to 0 volt. Therefore, the voltage converting unit 62 determines that the voltage applied to the first electrode as the selection target is “0 volt” and outputs a determination result to the output driver 63.

When the negative voltage is applied to the first electrode as the selection target, in FIG. 19, the data signal is “1” and the FR is “0”. Output voltage corresponding to this combination is “V0”. The output voltage V0 corresponds to 24 volts. Therefore, the voltage converting unit 62 determines that the voltage applied to the first electrode as the selection target is “24 volts” and outputs a determination result to the output driver 63.

When the positive voltage is applied to the first electrodes as the non-selection targets, in FIG. 19, the data signal is “0” and the RF is “1”. Output voltage corresponding to this combination is “V21C”. The output voltage V21C corresponds to 18 volts. Therefore, the voltage converting unit 62 determines that the voltage applied to the first electrodes as the non-selection targets is “18 volts” and outputs a determination result to the output driver 63.

When the negative voltage is applied to the first electrodes as the non-selection targets, in FIG. 19, the data signal is “0” and the FR is “0”. Output voltage corresponding to this combination is “V34C”. The output voltage V34C corresponds to 6 volts. Therefore, the voltage converting unit 62 determines that the voltage applied to the first electrodes as the non-selection targets is “6 volts” and outputs a determination result to the output driver 63.

Voltage notified to the output driver 73 by the voltage converting unit of the segment driver 53 is explained. For example, the voltage conversing unit 72 stores a second voltage conversion table. The voltage converting unit 72 determines voltage applied to the second electrodes to correspond to such a second voltage conversion table. FIG. 20 is a diagram of an example of data structure of the second voltage conversion table. As illustrated in FIG. 20, the second voltage conversion table associates a data signal, FR, and output voltage.

The data signal corresponds to values of bit strings included in image data. The FR is information for identifying whether voltage applied to the second electrodes is positive voltage or negative voltage. When the FR is “1”, the positive voltage is applied to the second electrodes. When the FR is “0”, the negative voltage is applied to the second electrode.

The output voltage is information for identifying voltage output from the output driver 73. The output voltages V0, V21S, and V34S correspond to voltages output from the amplifiers 56f, 56h, and 56i illustrated in FIG. 18, respectively. Specifically, V0 is 24 volts, V21S is 12 volts, and V34S is 12 volts. The output voltage V5 is 0 volt.

In the following explanation, voltage applied to the nth second electrode is determined. When the nth bit of image data is “1” and positive voltage is applied, in FIG. 20, the data signal is “1” and the FR is “1”. Output voltage corresponding to this combination is “V0”. The output voltage V0 corresponds to 24 volts. The voltage converting unit 72 determines that the voltage applied to the nth second electrode is “24 volts” and outputs a determination result to the output driver 73.

When the nth bit of the image data is “1” and negative voltage is applied, in FIG. 20, the data signal is “1” and the FR is “0”. Output voltage corresponding to this combination is “V5”. The output voltage V5 corresponds to 0 volt. The voltage converting unit 72 determines that the voltage applied to the nth second electrode is “0 volt” and outputs a determination result to the output driver 73.

When the nth bit of the image data is “0” and positive voltage is applied, in FIG. 20, the data signal is “0” and the FR is “1”. Output voltage corresponding to this combination is “V21S”. The output voltage V21S corresponds to 12 volts. The voltage converting unit 72 determines that the voltage applied to the nth second electrode is “12 volts” and outputs a determination result to the output driver 73.

When the nth bit of the image data is “0” and negative voltage is applied, in FIG. 20, the data signal is “0” and the FR is “0”. Output voltage corresponding to this combination is “V34S”. The output voltage V34S corresponds to 12 volts. The voltage converting unit 72 determines that the voltage applied to the nth second electrode is “12 volts” and outputs a determination result to the output driver 73.

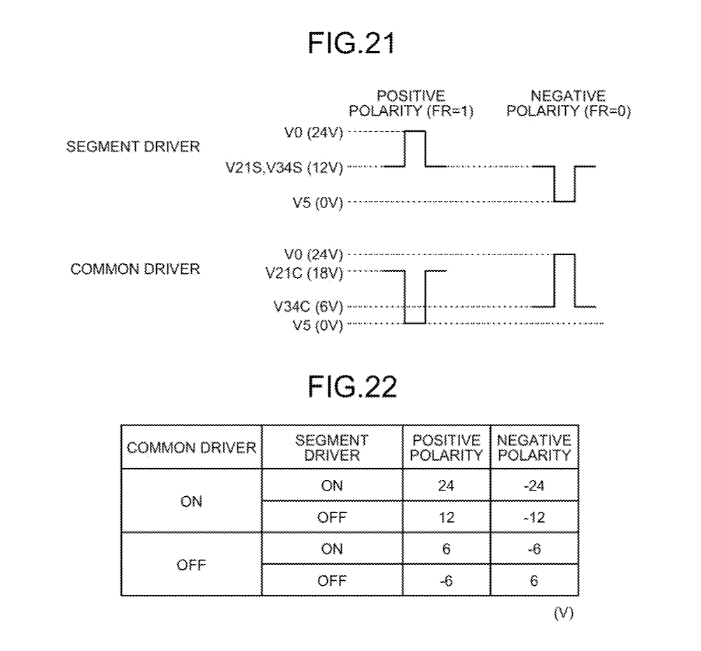

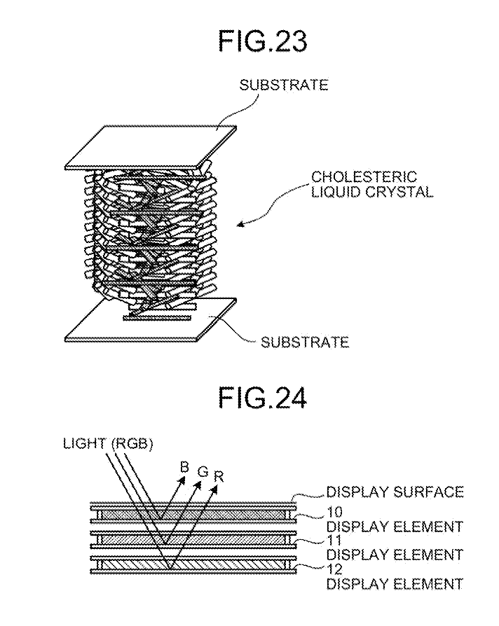

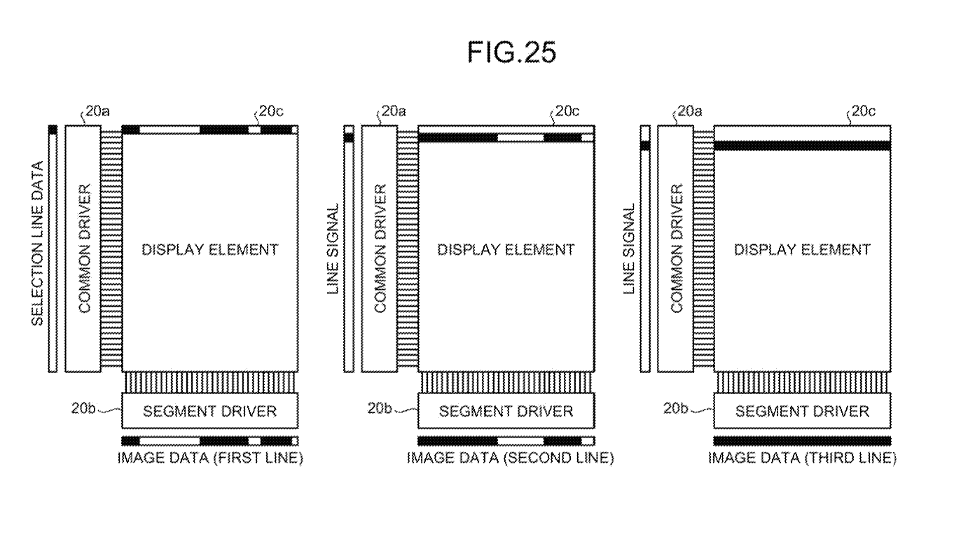

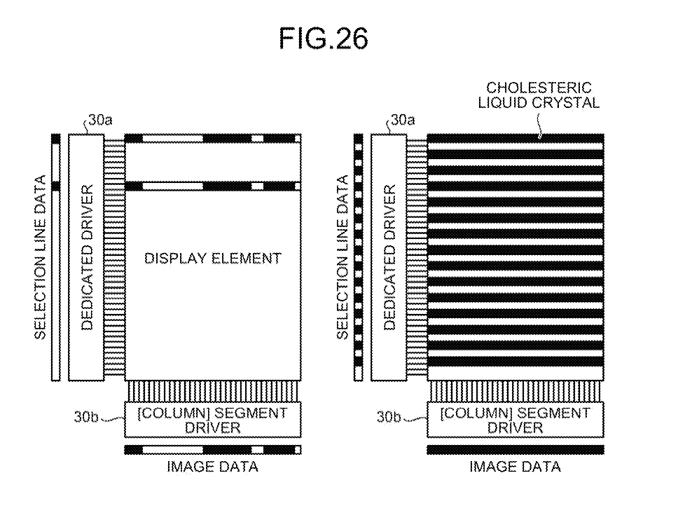

FIG. 21 is a diagram of waveforms of voltages output from the common driver 52 and the segment driver 53. On the left side in FIG. 21, waveforms of positive voltages output from the drivers are illustrated. As illustrated on the upper left of FIG. 21, the segment driver 53 outputs a voltage of 12 volts or 24 volts to the second electrodes. As illustrated on the lower left in FIG. 21, the common driver 52 outputs a voltage of 18 volts or 0 volt to the first electrodes.

On the right side in FIG. 21, waveforms of negative voltages output from the drivers are illustrated. As illustrated on the upper right of FIG. 21, the segment driver 53 outputs a voltage of 12 volts or 0 volt to the second electrode. As illustrated on the lower right in FIG. 21, the common driver 52 outputs a voltage of 6 volts or 24 volts to the first electrodes.

In the display element 51, voltage is applied to each of areas where the first electrodes and the second electrodes cross. In the following explanation, the areas where the first electrodes and the second electrodes cross are referred to as crossing areas. FIG. 22 is a diagram illustrating voltage applied to the display element 51.

In FIG. 22, the first electrodes for which the common driver 52 is “ON” are the first electrodes as the selection targets. The first electrodes for which the common driver 52 is “OFF” are the first electrodes as the non-selection targets. The second electrodes for which the segment driver 53 is “ON” are electrodes corresponding to “1” of the image data. The second electrodes for which the segment driver 53 is “OFF” are electrodes corresponding to “0” of the image data.

As illustrated in FIG. 22, according to a combination of ON or OFF of the common driver, ON or OFF of the segment driver, positive polarity, and negative polarity, a voltage of any one of −24 volts, −12 volts, −6 volts, 6 volts, 12 volts, and 24 volts is applied to the crossing areas.

Specifically, when the common driver is ON and the segment driver is ON, when the positive voltage is applied, 24 volts is applied to the first electrodes and 0 volt is applied to the second electrodes. As a result, a voltage of 24 volts is applied to the crossing areas.

When the common driver is ON and the segment driver is ON, when the negative voltage is applied, 0 volt is applied to the first electrodes and 24 volts is applied to the second electrodes. As a result, a voltage of −24 volts is applied to the crossing areas.

When the common driver is ON and the segment driver is OFF, when the positive voltage is applied, 0 volt is applied to the first electrodes and 12 volts is applied to the second electrodes. As a result, a voltage of 12 volts is applied to the crossing areas.

When the common driver is ON and the segment driver is OFF, when the negative voltage is applied, 24 volts is applied to the first electrodes and 12 volts is applied to the second electrodes. As a result, a voltage of −12 volts is applied to the crossing areas.

When the common driver is OFF and the segment driver is ON, when the positive voltage is applied, 18 volts is applied to the first electrodes and 24 volts is applied to the second electrodes. As a result, a voltage of 6 volts is applied to the crossing areas.

When the common driver is OFF and the segment driver is ON, when the negative voltage is applied, 6 volts is applied to the first electrodes and 0 volt is applied to the second electrodes. As a result, a voltage of −6 volts is applied to the crossing areas.

When the common driver is OFF and the segment driver is OFF, when the positive voltage is applied, 18 volts is applied to the first electrodes and 12 volts is applied to the second electrodes. As a result, a voltage of −6 volts is applied to the crossing areas.

When the common driver is OFF and the segment driver is OFF, when the negative voltage is applied, 6 volts is applied to the first electrodes and 12 volts is applied to the second electrodes. As a result, a voltage of 6 volts is applied to the crossing areas.

A distribution of voltages applied to the display element 51 is equal to the distribution of the voltages illustrated in FIG. 10 irrespective of positive polarity and negative polarity.

The common driver 52 of the display device 50 can only select the first electrodes one by one and cannot select the first electrodes at a time unlike the segment driver 220. Therefore, the display device 200 can more quickly cope with a change of an image than the display device 50. The common driver 52 of the display device 50 and the segment driver 220 of the display device 200 are the drivers of the same type. Therefore, the display device 200 can be manufactured at cost same as that for the display device 50.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A panel module comprising:
a display element in which voltage is applied to a plurality of first electrodes arrayed on a substrate and a plurality of second electrodes arrayed in a direction different from a direction of the first electrodes, the display element changing a state of liquid crystal according to voltage of areas where the first electrodes and the second electrodes cross;
an inverting unit that acquires polarity data indicating whether positive voltage is applied or negative voltage is applied to the first electrodes and the second electrodes and image data displayed on the display element and outputs, based on the polarity data, inverted image data or un-inverted image data;
a first applying unit that selects one or more of the first electrodes corresponding to an area where the image data is displayed and applies, based on the polarity data, the positive voltage or the negative voltage to the selected one or more of the first electrodes; and
a second applying unit that applies, based on the polarity data and the image data output from the inverting unit, the positive voltage and the negative voltage to the second electrodes.

2. The panel module according to claim 1, wherein the inverting unit inverts the image data when the negative voltage is applied to the first electrodes and the second electrodes.

3. A driving circuit comprising:
an inverting unit that acquires polarity data indicating whether positive voltage is applied or negative voltage is applied to a plurality of first electrodes arrayed on a substrate of a display element and a plurality of second electrodes arrayed in a direction different from a direction of the first electrodes and image data displayed on the display element and outputs, based on the polarity data, inverted image data or un-inverted image data;
a first applying unit that selects one or more of the first electrodes corresponding to an area where the image data is displayed and applies, based on the polarity data, the positive voltage or the negative voltage to the selected one or more of the first electrodes; and
a second applying unit that applies, based on the polarity data and the image data output from the inverting unit, the positive voltage and the negative voltage to the second electrodes.

4. A display device comprising:
a display element in which voltage is applied to a plurality of first electrodes arrayed on a substrate and a plurality of second electrodes arrayed in a direction different from a direction of the first electrodes, the display element changing a state of liquid crystal according to voltage of areas where the first electrodes and the second electrodes cross;
a control unit that outputs polarity data indicating whether positive voltage is applied or negative voltage is applied to the first electrodes and the second electrodes and image data displayed on the display element;
an inverting unit that acquires the polarity data and the image data and outputs, based on the polarity data, inverted image data or un-inverted image data;
a first applying unit that selects one or more of the first electrodes corresponding to an area where the image data is displayed and applies, based on the polarity data, the positive voltage or the negative voltage to the selected one or more of the first electrodes; and
a second applying unit that applies, based on the polarity data and the image data output from the inverting unit, the positive voltage and the negative voltage to the second electrodes.

5. A computer readable storage medium having stored therein a control program causing a computer to execute a process, the computer including a first driver that applies voltage to a plurality of first electrodes arrayed on a substrate of a display element and a second driver that applies voltage to a plurality of second electrodes arrayed in a direction different from a direction of the first electrode, the process comprising:
acquiring polarity data indicating whether positive voltage is applied or negative voltage is applied to the first electrodes and the second electrodes and image data displayed on the display device;
outputting, based on the polarity data, inverted image data or un-inverted image data;
selecting one or more of the first electrodes corresponding to an area where the image data is displayed;
outputting, to the first driver, information indicating that the positive voltage or the negative voltage is applied to the selected one or more of the first electrodes based on the polarity data; and
notifying the second driver of information indicating that the positive voltage and the negative voltage is applied to the second electrodes based on the polarity data and the image data output from a processing result of the outputting the image data.
